(19) United States
(12) Patent Application Publication
(10) Pub. No.: US 2011/0145146 A1
(43) Pub. Date: Jun. 16, 2011

(54) Off-Line Account Recharging

(75) Inventor: Qingqing You, Hangzhou (CN)

(73) Assignee: Alibaba Group Holding Limited, Grand Cayman (KY)

(21) Appl. No.: 12/600,565

(22) PCT Filed: Sep. 4, 2009
(86) PCT No.: PCT/US09/56102

§ 371 Date: Nov. 17, 2009

(30) Foreign Application Priority Data
Sep. 4, 2008 (CN) 200810212240

(51) Int. Cl. G06Q 40/00

(52) U.S. Cl. 705/44

(57) ABSTRACT

A method for off-line account recharging allows recharging of a user account at a simple payment node without sophisticated account interface. The method does not require the user to have an online bank account. The user enters a recharge amount and a mobile device number at the payment node, which sends the entered recharge information to a server where the user account is held. The server generates a recharge code which corresponds to the recharge amount and the mobile device number, and provides the recharge code to the user. The user uses the received recharge code to contact the server and complete the account recharge. The server may perform additional identity verification using the mobile device number and a random challenge code when the user requests to complete the count recharge. The recharge process does not require complex account information to be entered.

### RELATED APPLICATIONS

This application is a national stage application of international patent application PCT/US09/56102 fled Sep. 4, 2009, entitled “OFF-LINE ACCOUNT RECHARGING”, which claims priority from Chinese patent application, Application No. 200810212240.2, filed Sep. 4, 2008, entitled “METHOD AND SYSTEM FOR OFF-LINE ACCOUNT RECHARGING”, which applications are hereby incorporated in their entirety by reference.

### TECHNICAL FIELD

The present disclosure relates to fields of network resource data processing, and particularly to methods and systems for off-line account recharging.

### BACKGROUND

As network technologies continue to develop, a variety of e-commerce services and virtual resources are now provided over a network to users. These transactions generally involve conventional currency. Earlier transactions use cash as a payment method when conducting a virtual property transaction. However, this payment method can guarantee neither the speed of a payment nor the security of associated transaction. Third-party payment systems therefore emerge to provide a third-party virtual account for a user. The user may complete a transaction payment by recharging the virtual account.

In existing technologies, as a part of a third-party virtual account process, the user may first have conventional currency exchanged into an online bank's electronic currency, and then have the bank's electronic currency exchanged into an appointed virtual currency. A prerequisite for this process requires, however, a user to open an account in the online bank in the first place. The procedures for opening and recharging an account are complicated, coupled with poor security and limited transaction amount for the online bank's public edition, and the requirement of installing a client end digital certificate by the online bank's professional edition. As a result, this method is only used by a small number of users, and has failed to receive widespread use. Therefore, development of third-party payment service is severely hindered.

The above deficiencies of the existing technologies also exist in various account recharging processes such as online games, mobile phone communication, and landline phone communication. As a result, off-line account recharging methods have been developed, which allow a user to conveniently and quickly complete account recharging without opening an online bank account by the user. These off-line account recharging methods generally require completing account recharging at a recharging spot which provides a payment node. A payment node may have a variety of business modes such as a convenience store, wireless recharge, and a kiosk. Different nodes may have different operating methods. For example, convenience store uses a register, wireless recharge uses a mobile phone, and a kiosk uses an automated device for swiping cards.

However, recharging an account at a recharging spot requires entering the information of the account that is being recharged for identity verification. As payment nodes such as a register and a kiosk generally only allow inputting numbers without an adequate input function for alphabets, it can be very difficult or even impossible to enter certain relatively complicated account information (e.g., an account name containing letters and special characters) in the payment node.

Therefore, there is a need to recharge an account that has complex account information using a payment node that only allows simple numeric input. There is also a need to allow recharging to be independent of an online bank.

### SUMMARY OF THE DISCLOSURE

The present disclosure is a method and a system for off-line account recharging used for solving the difficulty of positioning an account having a complicated account name. In one embodiment, the disclosed method uses a mobile device that is carried along by a user as a means to identify the user. When the user conducts an account recharging at a service node such as a service terminal, the node sends recharge information to a server where the user account being recharged is held. The recharge information is based on the mobile phone number and a recharging amount of the user. The server generates a recharge code which corresponds to the mobile phone designated by the user and sends the recharge code to the user either directly or through the service node. Upon obtaining the recharge code, the user may complete the account recharge. As illustrated, this method does not require entering complex account information into a service node for identity verification. Instead, a mobile phone number is entered at the service node, thus avoiding the difficulty of positioning an account. Therefore, account recharging can be carried out by simple service nodes that may not have sophisticated an account interface even if the user account may have complex account information.

In one embodiment, the server is part of a third-party payment system hosting multiple user accounts. Upon obtaining the recharge code, the user logs into the third-party payment system for account recharging.

In one embodiment the server sends a dynamic command or code as a challenge code for the recharge code to the designated mobile device. The server requires that the user enter the correct challenge code in order to complete the account recharging. Alternatively, the user account may be bound with the mobile phone number. Upon obtaining the recharge code, the user may complete the account recharge on the server through text messaging or voice messaging directly using the designated mobile phone. The server can use the mobile phone number for verifying the identity of the user in order to complete the account recharge. The disclosed method separates the recharge code from the password in both time and location to effectively ensure security of associated resource. The recharge code may be displayed in plain text. Even if the recharge code is lost, it can be recovered through the third-party payment system, without affecting its use by the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 shows a flow chart of an exemplary method in accordance with the present disclosure.

FIG. 2 shows a flow chart of another exemplary method in accordance with the present disclosure.

FIG. 3 shows an exemplary system and application environment in accordance with the present disclosure.

FIG. 4 shows a first exemplary account structure used in the disclosed system.

FIG. 5 shows a second exemplary account structure used in the disclosed system.

### DETAILED DESCRIPTION

The method and the system are described below in further detail using accompanying figures and specific exemplary embodiments.

In this description, “off-line account recharging” generally means a process or method for recharging a user account using an intermediary payment node which is not an online bank account capable of making integrated single stop payment and recharge of the user account. Off-line account recharging allows a user to conveniently and quickly complete account recharging without opening an online bank account by the user. A payment node may have a variety of business modes such as a convenience store, wireless recharge, and a kiosk. Different nodes may have different operating methods. For example, convenience store uses a register, wireless recharge uses a mobile phone, and a kiosk uses an automated device for swiping cards.

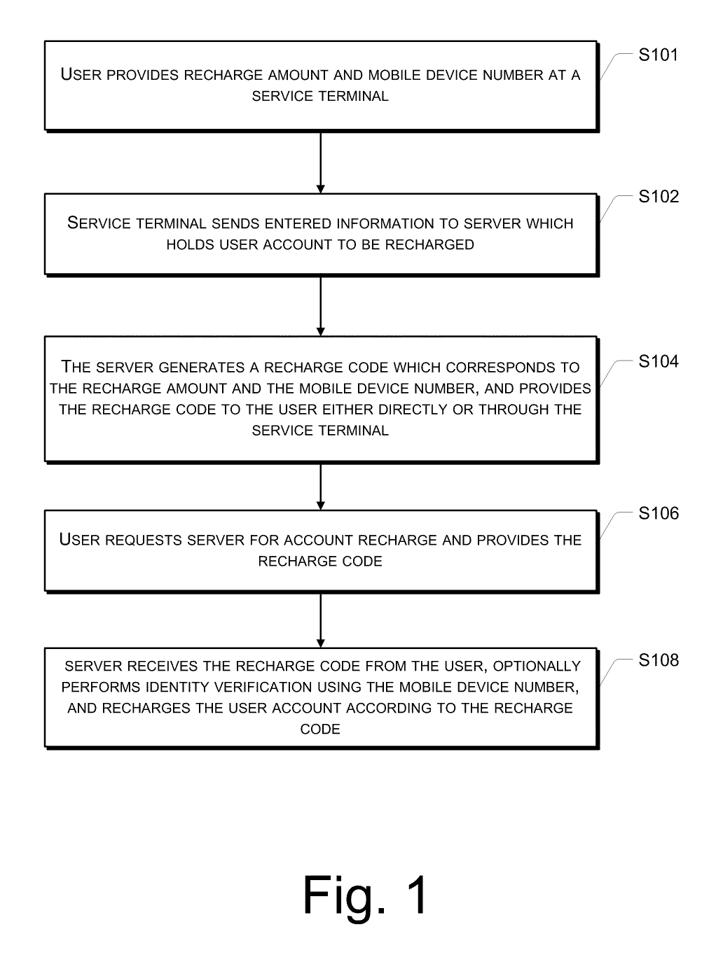

FIG. 1 shows an exemplary method for off-line account recharging in accordance with the present disclosure. The method includes a procedure described as follows. In this description, the order in which a process is described is not intended to be construed as a limitation, and any number of the described process blocks may be combined in any order to implement the method, or an alternate method.

S101: A user provides a recharge amount and a mobile phone number at a service terminal. In a typical scenario, the user visits the service terminal at a payment node to make a payment in order to recharge an account held at a server of a payment system, as will be further described below. The service terminal may be provided by a business partner of the payment system. The partner may be a financial service company, or an ordinary merchant or vendor. The service terminal is a service node which may be a front desk of a bank system, a kiosk, postal service, a credit union, etc. The user may bring along a recharge amount to a location that has such a service terminal, provide or input the recharge amount and the number of a mobile device through the service terminal, which then sends the entered information (i.e., the recharge amount and the mobile phone number) to the server of the payment system as described below. In a typical application, the user makes an actual payment to the business partner at the service terminal The payment system honors the payment made by the user to the business partner based on established financial relationship between the payment system and the business partner.

The mobile device may be any suitable communication device such as a mobile phone, a personal handphone system, or other portable devices that can send and receive information. Desired characteristics for the mobile device are portability and possession of a unique identifier, which is generally represented by numbers (e.g., a mobile phone number). The unique identifier may be used for verifying the identity of a user.

S102: The service terminal sends the entered recharge information to a server. The server may be a server for any e-commerce services which needs or supports online payment. Examples include an online gaming server and a third-party payment system.

S104: The server generates a recharge code which corresponds to the recharge amount and the user mobile device number, and provides the recharge code to the user. The correspondence between the recharge code and the recharge amount and the user mobile device number can be in any form and does not have to be mathematically based, but only needs to provide an indication to the server that the particular recharge code was created in association with the recharge amount and the user mobile device number.

Upon receiving the recharge amount and the mobile device number from the service terminal, the server may determine the validity and the authenticity of the associated transaction before generating a recharge code and providing the recharge code to the user.

A variety of methods may be used for providing the recharge code to the user. For example, the generated recharge code may be returned to the service terminal which may then provide (e.g., by displaying, messaging, or printing) the recharge code to the user. If the service terminal does not have the necessary conditions for completing this operation, the server may alternatively send the generated recharge code to the user directly, for example, through text messaging to the mobile device of the user.

In order to facilitate information verification by the user, the server may further provide related information such as the recharge amount and the mobile device number to the user. The user may check the information in order to avoid any loss due to operation errors.

S106: The user subsequently requests to complete the account recharging. This may happen anytime at the user's choice. The recharging may either be initiated at the present mobile device, another mobile device, or any other user terminal (such as a computer or portable device) connected to the server.

S108: The server receives the recharge code from the user and recharges the user account according to the recharge code.

The server recharge is the user account only if the user passes a verification challenge. The verification challenge may include at least a match between the user input recharge code received from the user and the recharge code generated by the server, but may include further requirements as described below.

In the simplest form which requires no further verification beyond the recharge code itself, the server may receive the recharge code and recharge the user account according to the user requests, assuming that the recharge code is in the hand of the right user. However, security may be a concern at this step, and may require certain form of verification or authentication. For example, there may be a concern that the recharge code is lost or stolen and is now used by an unintended party. In this case, even if the user trying to recharge an account is required to enter the correct account information by the server, the recharge code may still be misused because it may have fallen to the hands of someone who did not make the payment at the service terminal but does have a legitimate user account. Further verification therefore may be desirable.

One exemplary verification method is to use the previously received mobile device number for identity verification. The server first confirms that the user is the owner or in control of the designated mobile device before allowing the user account to be recharged using the corresponding recharge code. The mobile device may be directly verified if the server has means to detect or determine the mobile device number automatically when the user is using the mobile device to connect to the server to request account recharge.

Alternatively, the server may generate and send a challenge code to the mobile device and require the user to enter the received challenge code in order to verify that the user is the owner of or has access to the designated mobile device. The challenge code may be a random code or command. This will be further described below in the exemplary embodiments.

It should be noted that before the above blocks 5106 and 5108, the recharge amount has not yet been made into the user account held at the server of the account system. The user has made a payment to the business partner of the account system at the service terminal and received a recharge code. If the user wants to complete the recharging of the account, the user will need to make a recharge request to the server, as described above at block 5106. In order to ensure the authenticity of the transaction, the user may not be allowed to complete account recharging simply by providing the recharge code, but may be further required to provide other credentials such as the mobile device number for identity verification. Only when verification is successful will the server recharge the amount corresponding to the recharge code into the user's account.

Described above is an exemplary method for off-line account recharging. In the disclosed embodiments, no account information such as the account name and password of the user is required to be entered into the service terminal. The account recharging can be completed using a simple service terminal that may only allow inputting numbers and does not have sophisticated account interface capabilities. The method effectively overcomes the difficulty of positioning a user account using certain type of service terminals.

The user may use various types of available means to complete account recharge upon obtaining a recharge code. In one example, the user may log into his/her account at the server using the Internet and enter the recharge code to complete account recharge. Upon receiving a recharge request of the user, the server may verify identity of the user using a suitable method described herein. The server sends a challenge code such as a dynamic command to the user through text messaging to the mobile device number that corresponds to the recharge code, and instructs the user to input the received challenge code. If the user inputs the correct challenge, the user passes identity verification. The server makes a recharge of the recharge amount corresponding to the recharge code into the user's account.

One exemplary approach treats the dynamic command or code as a password or challenge code of the recharge code, and separates the recharge code from the password in both time and location to enhance the security. The recharge code itself may be displayed in plain text. Even if the recharge code is lost, the user may still re-apply and obtain the recharge code from the server. The server may re-send the recharge code to the user's mobile device upon verifying the user and transaction information such as the time and place of payment made at the service terminal, the recharge amount, and the mobile device number, to allow normal use of the recharge code by the user.

Another exemplary approach is to complete account recharge using text messaging or voice messaging of the mobile device. Under this circumstance, the mobile device number of the user may be bound with the user account in advance. After the user sends the recharge code to the server through a mobile device, the server may directly detect or determine whether the mobile device used for requesting the account recharging is the same as the mobile device used to generate the recharge code in order to verify the user identity. For example, if the server determines that the second mobile device number is the same as the first mobile device number, the server may directly recharge the amount which corresponds to the recharge code into the account that has been bound with the mobile device. Alternatively, if the user does not use the original mobile device to request the account recharging, the server may provide an opportunity for the user to pass a similar verification challenge by providing evidence that he or she is the owner of or has access to the original mobile device number. With the above-described configurations, the user may complete account recharging without logging into the server. This further simplifies the process of account recharging and improves the efficiency.

It is noted that the method of completing account recharging by a mobile device may also be used for recharging an account of a user other than the user who made the payment and obtained a recharge code at a service terminal. For example, suppose user U1 binds his/her mobile device number N1 with his/her account. User U2 uses his/her mobile device number N2 to obtain a recharge code. User U2 may complete account recharge in a server through his/her mobile device number N2, and recharge a recharge amount corresponding to the recharge code into the account of the user U1 which has been bound with the mobile device number N1. In order to do this, the server may be configured to only require that user U2's mobile device number N2 match the mobile device number used for generating the recharge code, and does not require that the target account that is being recharged to match user U2's identity or the mobile device number N2. In other words, the focus of the verification challenge in the disclosed method is to verify the true ownership of the recharge code which is associated with a payment made at a service terminal, not the ownership of the user account that is being charged.

In practice, the server handles multiple users and multiple service terminals. To more efficiently process the transactions of multiple users and multiple service terminals, various accounts may be set up a between the payment account system, the business partner and the user. For example, the server may open an off-line resolving account in advance, and use the resolving account to store a recharge amount that has been paid by the user at a service terminal but has not been transferred to the user account. Prior to generating a recharge code, a procedure for making a payment and settling accounts may be carried out in order to maintain a proper balance of the funds and to ensure normal operation. A variety of approaches may be used for this procedure. Two exemplary are described below, which are only used for illustration, and should not be construed as a limitation to the present disclosure.

According to a first approach, a business partner of the payment system opens a partner account held in a server of the payment account system, and charges the partner account in advance. Upon receiving recharge information from the service terminal, the server first determines whether the partner account has sufficient fund. If the partner account has sufficient fund, the server deducts an equivalent amount of the present recharge amount from the partner account, and transfers the amount into the pre-opened off-line resolving account. When the user requests to complete the account recharging using the recharge code and has passed the verification challenge, the server may transfer the relevant amount from the off-line resolving account to the user account. This way, the business partner does not need to make a fund transfer to the payment account system for each user payment, but rather maintains a balanced partner account at the payment account system and settle the partner account periodically. With each recharge transaction, as the partner receives the user's payment first, the payment system has a basis to deduct a corresponding amount from the partner account.

The above method is more suitable for use when the partner is an ordinary merchant or vendor. When the partner is a financial company or institute, the following alternative method may be preferred.

According to a second approach, the server (or more exactly the owner of the payment account system) opens a financial account at a financial system of a business partner, and may recharge the financial account. In this configuration, after the server receives recharge information from the service terminal, the server may transfer the present recharge amount from the financial account into the pre-opened off-line resolving account as an advanced payment. When the user requests to complete the account recharging using the recharge code and has passed the verification challenge, the server may transfer the relevant amount from the off-line resolving account into the user account. The business partner may subsequently transfer the recharge amount into the server's financial account after the transaction is completed to ensure a balance. It is noted that the financial business partner which holds the financial account of the server of the payment account system may or may not be the same as the owner of the service terminal. In case where they are not the same entities, proper fund remittance between the financial business partner and the owner of the service terminal may need to be arranged.

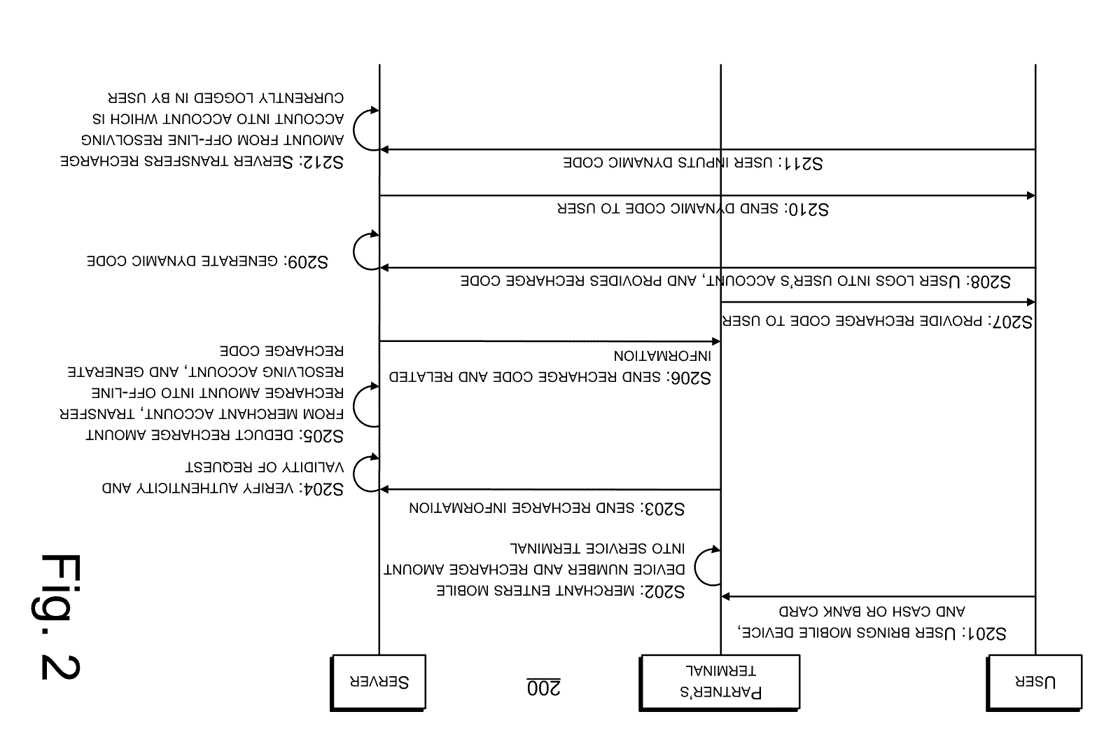

FIG. 2 shows an example where the business partner is an ordinary merchant or vendor. The merchant opens a merchant account at a server of the payment system, and pre-charges the account in advance. Mobile device of a user may be a mobile phone. The user logs into his/her account to complete account recharge. The method includes the procedures described as follows.

S201: The user brings a mobile device and cash or any bank card to a service terminal of the merchant.

S202: An operator of the merchant enters recharge information such as recharge amount and mobile device number according to the request of the user.

S203: The merchant's service terminal sends a recharge request to a server.

S204: The server verifies the authenticity and the validity of the request.

S205: Upon successful verification, the server determines whether a merchant account has sufficient fund. If the merchant account has sufficient funds, the server deducts an equivalent amount of the recharge amount from the merchant account, and transfers the amount to an off-line resolving account. At the same time the server generates a unique recharge code which corresponds to the recharge information received.

S206: The server returns information about the generated recharge code, the mobile device number, the recharge amount, and a result of advanced payment to the merchant's service terminal.

S207: The merchant's service terminal provides the recharge code to user upon receipt, and accepts payment for the recharge amount of the user. The merchant may charge an additional handling fee to the user.

S208: The user logs into his/her account held at the payment system through the server, and inputs the recharge code to complete account recharge.

S209: Upon receiving the recharge code, the server generates a dynamic code or command.

S210: The server sends the dynamic code to the user at the mobile device number which corresponds to the recharge code.

S211: Upon receiving the dynamic code through the mobile device, the user inputs the dynamic code to the server.

S212: Upon determining that the received code is correct, the server transfers the recharge amount corresponding to the recharge code from the off-line resolving account to the user account presently logged in by the user.

The above-described method and procedures may be implemented using a computer or computer system, such as a server computer, as described below.

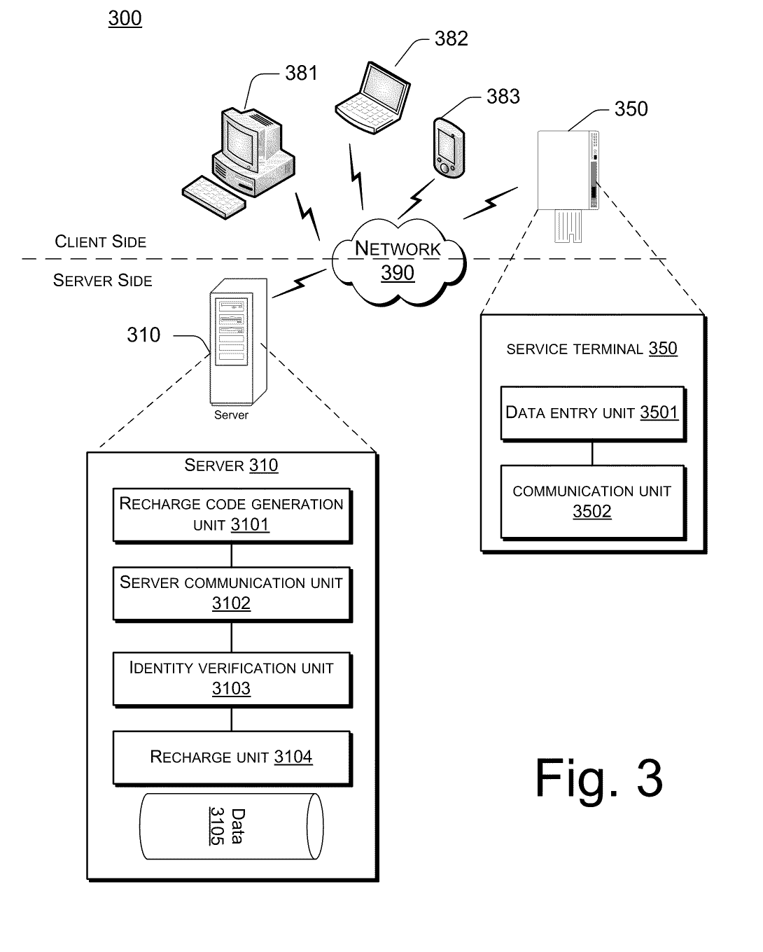

FIG. 3 shows a schematic structural diagram of an exemplary account recharging system in an exemplary environment. Account recharging system is implemented with a server 310 which is placed in exemplary environment 300 for implementing the method of the present disclosure. As illustrated in environment 300, some components reside on a client side and other components reside on a server side. However, these components may reside in multiple other locations. Furthermore, two or more of the illustrated components may combine to form a single component at a single location.

The server 310 is connected to client-side computing devices such as client terminals 381, 382 and 383 and business partner service terminals 350 through network(s) 390, such that users (not shown) may access the account recharging system 350 through the client-side computing devices and the service terminal 350. In one embodiment, client-side computing devices 381, 382 and 383 may each be a computer or a portable device, used as a user terminal. The service terminal 350 may be a kiosk or register for taking payment, either attended or unattended. The server 310 may include common computer components such as processor(s), I/O devices, computer readable media, and network interface (not shown).

The computer readable media stores application program modules and data 3105 (such as user account information and partner account information). Application program modules contain instructions which, when executed by processor(s), cause the processor(s) to perform actions of a process described herein. It is appreciated that the computer readable media may be any of the suitable storage or memory devices for storing computer data. Such storage or memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

It is also appreciated that a computing system or device may be any device that has a processor, an I/O device and a memory (either an internal memory or an external memory), and is not limited to a personal computer. Especially, server 310 may be a server computer, or a cluster of such server computers, connected through network(s) 390, which may either be the Internet or an intranet. Especially, the server 310 may be a web server, or a cluster of such servers hosting a website such as an e-commerce site.

In one embodiment, the service terminal 350 and the server 310 are configured to have various functional modules to perform the functions described herein.

As shown in FIG. 3, the service terminal 350 includes a data entry unit 3501 used for entering a recharge amount and a mobile device number of a user, and a communication unit 3502 used for sending entered recharge information to a server.

The server 310 includes several units programmed or adapted to perform various functions described herein. For example, a recharge code generation unit 3101 is programmed for generating a recharge code which corresponds to a recharge amount and a mobile device number of a user received from a service terminal. A communication unit 3102 is programmed for receiving the recharge amount and the mobile device number from the service terminal and providing the recharge code to the user. An identity verification unit 3103 is programmed for performing identity verification using the mobile device number when the user requests to recharge a user account held on the server. A recharge unit 3104 is programmed for recharging the user account according to the recharge code upon successful verification.

In operation, based on a user request, the service terminal 350 enters a recharge amount of through the entry unit 3501, and then sends the entered recharge information including the recharge amount and the user's mobile device number to the server 310 through the communication unit 3502. After the server 310 receives the recharge information from the service terminal 350, the recharge code generation unit 3101 generates a recharge code which corresponds to the recharge amount and the mobile device number. The server's communication unit 3102 then provides the recharge code to the user. When the user launches account recharging, the identity verification unit 3103 performs identity verification using the mobile device number. Upon successful verification, the recharge unit 3104 recharges an account of the user according to the recharge code.

As the user logs into his/her account through the server and enter the recharge code to complete account recharge, the server 310 may use a challenge code such as a dynamic command or code for further identity verification. Accordingly, the server 310 may be further programmed or adapted to perform the related functions described herein.

In practice, the server 310 handles multiple users and multiple service terminals 350. To more efficiently process the transactions of multiple users and multiple service terminals, various accounts may be set up amount the payment system, the partner and the user, as illustrated below.

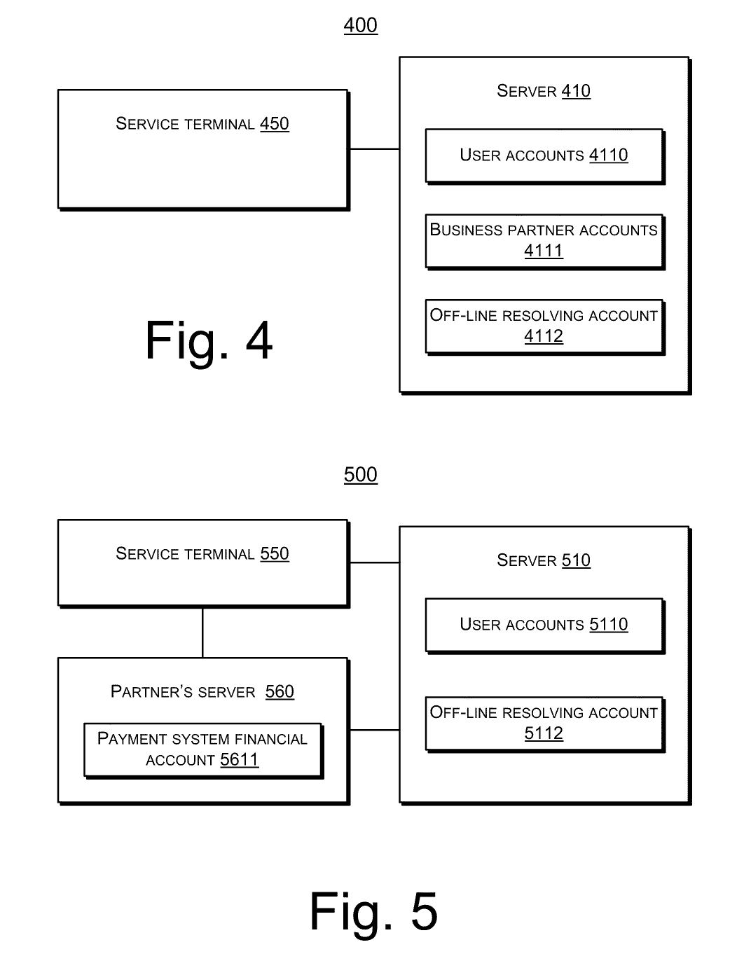

FIG. 4 shows a first exemplary account structure used for account recharge in accordance with the present disclosure. Server 410 of the payment system has user accounts 4110 which are used by the users to make payments for online transactions. A user uses the method and system disclosed herein to recharge a user account 4110 to maintain a proper balance. The payment account system sets up an off-line resolving account 4112 in server 410 in advance, and use the resolving account 4112 to store a recharge amount that has been paid by the user during an off-line account recharging but has not been transferred to the user's account. Prior to generating a recharge code, a procedure for making a payment and settling accounts may be carried out in order to maintain a proper balance among the funds and to ensure normal operation of the funds. A variety of approaches may be used for this procedure.

According to a first approach sure in FIG. 4, a business partner (e.g., the owner of service terminal 450) of the payment system opens a business partner account 4111 in the server 410 of the payment system, and charges the account in advance. Upon receiving recharge information from the service terminal 450, the server 410 first determines whether the partner account 4111 has sufficient fund. If the partner account 4111 has sufficient fund, the server 410 deducts an equivalent amount of the present recharge amount from the partner account 4111, and transfers the amount into the pre-opened off-line resolving account 4112. After the user requests to complete the account recharging using the recharge code and has passed the verification challenge, the server 410 may transfer the relevant amount from the off-line resolving account 4112 to the user account 4110. This way, the business partner does not need to make a fund transfer to the payment system for each user payment, but rather maintain a balanced partner account 4111 at the payment system and settle the partner account 4111 periodically. With each recharge transaction, as the business partner receives a user's fund through server terminal 450 first, the payment system has a basis to deduct a corresponding amount from the partner account 4111. This method is more suitable for use when the partner is an ordinary merchant or vendor. When the partner is a financial company or institute, the following alternative method may be preferred.

FIG. 5 shows a second exemplary account structure used for account recharge in accordance with the present disclosure. Server 510 of the payment system has user accounts 5110 which are used by the users to make payments for online transactions. According to a second approach, the server 510 (or more exactly the owner of the payment system) opens a financial account 5611 at a financial system server 560 of a business partner, and may recharge the financial account 5611 when needed. The financial system server 560 is an external server of a business partner related to the service terminal.

After the server 510 of the payment system receives recharge information from the service terminal 550 of the business partner, the server 510 may transfer the present recharge amount from the financial account 5611 into the pre-opened off-line resolving account 5112 as an advanced payment. When the user requests to complete the account recharging using the recharge code and has passed the verification challenge, the server 510 may transfer the relevant amount from the off-line resolving account 5112 into the account 5110 of the user. The business partner may subsequently transfer the recharge amount into the payment system's financial account 5611 after the transaction is completed to ensure a balance.

In the presence disclosure, a “module” or a “unit” in general refers to a functionality designed to perform a particular task or function. A module or a unit can be a piece of hardware, software, a plan or scheme, or a combination thereof, for effectuating a purpose associated with the particular task or function. In addition, delineation of separate units does not necessarily suggest that physically separate devices are used. Instead, the delineation may be only functional, not structural, and the functions of several units may be performed by a single combined device or component. When used in a computer-based system, regular computer components such as a processor, a storage and memory may be programmed to function as one or more units or devices to perform the various respective functions.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method for off-line account recharging, the method comprising:
receiving at a server from a service terminal a recharge amount and a mobile device number of a user;
generating a recharge code which corresponds to the recharge amount and the mobile device number;
providing the recharge code to the user;
receiving a user input recharge code from the user requesting for recharging a user account;
recharging the user account by the recharge amount if the user passes a verification challenge, the verification challenge including at least a match between the user input recharge code received from the user and the recharge code generated by the server.

2. The method as recited in claim 1, further comprising:
receiving at the server a user input mobile device number from the user requesting for recharging the account, wherein the verification challenge further includes a match between the user input mobile device number received from the user and the mobile device number received from the service terminal.

3. The method as recited in claim 2, wherein the user requests for recharging the user account using a mobile device, and wherein receiving at the server the user input mobile device number from the user comprises:
automatically detecting the number of the mobile device used by the user for requesting recharging.

4. The method as recited in claim 1, wherein the verification challenge further includes evidence that user is requesting for recharging the user account using a mobile device having the same mobile device number received by the server from the service terminal.

5. The method as recited in claim 1, further comprising:
generating by the server a challenge code;
sending the challenge code to be mobile device number; and
receiving a user input challenge code from the user, wherein the verification challenge further includes a match between the user input challenge code and the challenge code generated by the server.

6. The method as recited in claim 1, wherein the mobile device number is bound with the user account in that the server deems the user to have passed the verification challenge upon detecting that the user is using the same mobile device number to request recharging the user account.

7. The method as recited in claim 1, wherein recharging the user account by the recharge amount comprises:
deducting the recharge amount from a business partner account related to the service terminal;
transferring the recharge amount into a pre-opened off-line resolving account; and
transferring the recharge amount from the off-line resolving account into the user account of the user.

8. The method as recited in claim 1, wherein recharging the user account by the recharge amount comprises:
transferring the recharge amount from a financial account to a pre-opened off-line resolving account, the financial account being owned by the server and held at an external server of a business partner related to the service terminal; and
transferring the recharge amount from the off-line resolving account into the user account.

9. The method as recited in claim 1, wherein the mobile device number is a mobile phone number.

10. A system for off-line account recharging, the system comprising a server computer which is programmed or adapted for performing the following acts:
receiving at a server from a service terminal a recharge amount and a mobile device number of a user;
generating a recharge code which corresponds to the recharge amount and the mobile device number;
providing the recharge code to the user;
receiving a user input recharge code from the user requesting for recharging a user account;
recharging the user account by the recharge amount if the user passes a verification challenge, the verification challenge including at least a match between the user input recharge code received from the user and the recharge code generated by the server.

11. The system as recited in claim 10, wherein the server computer is further programmed or adapted for performing the following acts:
receiving at the server a user input mobile device number from the user requesting for recharging the account, wherein the verification challenge further includes a match between the user input mobile device number received from the user and the mobile device number received from the service terminal.

12. The system as recited in claim 10, wherein the server computer is further programmed or adapted for performing the following acts:
generating by the server a challenge code;
sending the challenge code to be mobile device number; and
receiving a user input challenge code from the user, wherein the verification challenge further includes a match between the user input challenge code and the challenge code generated by the server.

13. A system for off-line account recharging, the system comprising a server computer including:
a recharge code generation unit programmed for generating a recharge code which corresponds to a recharge amount and a mobile device number of a user received from a service terminal;
a communication unit programmed for receiving the recharge amount and the mobile device number from the service terminal and providing the recharge code to the user;
an identity verification unit programmed for performing identity verification using the mobile device number when the user requests to recharge a user account held on the server; and
a recharge unit programmed for recharging the user account according to the recharge code upon successful verification.

14. The system as recited in claim 13, wherein the server computer further includes a data storage storing the user account, a business partner account related to the service terminal, and an off-line resolving account.

15. The system as recited in claim 13, wherein the server computer further includes a data storage storing the user account and an off-line resolving account, and wherein the server computer is adapted for accessing a financial account held at a business partner's server associated with the service terminal.
